(19) United States
(12) Patent Application Publication
(10) Pub. No.: US 2016/0345152 A1
(43) Pub. Date: Nov. 24, 2016

(54) HANDLING OF EMERGENCY CALLS OF A USER EQUIPMENT CONNECTED TO A WIRELESS ACCESS POINT

(71) Applicant: Deutsche Telekom AG, Bonn (DE)

(72) Inventors: Mari Melander, Bonn (DE); Michele Zarri, London (GB); Holger Debelts, Bonn (DE); Karl Heinz Nenner, Bornheim (DE); Rene Ververgaert, Bonn (DE); Georg Schweflinghaus, Koenigswinter (DE)

(21) Appl. No.: 15/156,346

(22) Filed: May 17, 2016

(30) Foreign Application Priority Data
May 18, 2015 (EP) 15 168 026

(51) Int. Cl. H04W 4/22; H04W 76/02

(52) U.S. Cl. CPC H04W 4/22; H04W 76/026; H04W 88/16

(57) ABSTRACT

A method for handling emergency calls includes: receiving, by a user equipment attached to a mobile communication network, emergency call capability information indicative of whether the mobile communication network supports an emergency service for the user equipment in a case where the user equipment is connected to the mobile communication network via a wireless access point connected to an external packet data network; and initiating, by the user equipment, an emergency call via the wireless access point or via an access network of the mobile communication network different from the wireless access point based on whether or not the emergency call capability information indicates that the mobile communication network supports the emergency service for the user equipment in the case where the user equipment is connected to the mobile communication network via the wireless access point.

### CROSS-REFERENCE TO RELATED APPLICATIONS

Priority is claimed to European Patent Application No. EP 15 168 026, filed on May 18, 2015, the entire disclosure of which is hereby incorporated by reference herein.

### FIELD

The present invention relates a method for improved handling of emergency calls of a user equipment being connected to a wireless access point while initiating an emergency call, wherein the user equipment is able to be connected to a mobile communication network via the wireless access point that is connected to an external packet data network.

Furthermore, the present invention relates to a mobile communication network and to a system for improved handling of emergency calls of a user equipment being connected to a wireless access point while initiating an emergency call, wherein the user equipment is able to be connected to a mobile communication network via the wireless access point that is connected to an external packet data network.

Additionally, the present invention relates to a user equipment, to a wireless access point, to a program and to a computer program product for improved handling of emergency calls.

The present invention generally relates to user equipments attaching to a mobile communication network via wireless local area networks (WLANs), also called WiFi access, to the mobile communication network, and, especially to supporting emergency calls for such user equipments in situations where these user equipments are connected to the mobile communication network using a WLAN access or a WiFi access, i.e. in a situation the user equipment is connected to the mobile communication network via a wireless access point.

### BACKGROUND

Existing wireless personal area networks (WPANs) or WLANs (Wireless Local Area Networks) traditionally do not have to support emergency calls as is the case for cellular networks or mobile communication networks. Support for emergency calls involves many aspects across all communication layers, especially signaling support and mandated procedures. The increased use of Voice over Internet Protocol (VoIP) in WLANs increases the need to also support emergency calls in WLAN-connected (or WiFi-connected) situations of user equipments. However, it typically cannot be guaranteed that an emergency call is able to be initiated by a user equipment in the sense that a specific user equipment, being in such a situation of being connected to a core network via a wireless access point, typically is not aware about whether the emergency call can be initiated via the wireless access point or not. This typically leads to the situation that—in an emergency situation, i.e. with the necessity to place an emergency call right away—precious time is wasted in trying, in a first step, to initiate the emergency call via the wireless access point only to discover that the connected core network does not support emergency calls in WiFi access situations, and, in a second step, to either reselect to a different access technology to place the emergency call in the same network or to try to attempt the emergency call using a different network.

### SUMMARY

In an embodiment, the invention provides a method for handling emergency calls. The method includes: receiving, by a user equipment attached to a mobile communication network, emergency call capability information indicative of whether the mobile communication network supports an emergency service for the user equipment in a case where the user equipment is connected to the mobile communication network via a wireless access point connected to an external packet data network; and initiating, by the user equipment, an emergency call via the wireless access point or via an access network of the mobile communication network different from the wireless access point based on whether or not the emergency call capability information indicates that the mobile communication network supports the emergency service for the user equipment in the case where the user equipment is connected to the mobile communication network via the wireless access point.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a mobile communication network and a system according to the present invention, comprising a packet data core network, at least one access network as well as a wireless access point connected to the mobile communication network, wherein the wireless access point is able to connect a user equipment to the mobile communication network.

FIG. 2 schematically illustrates a communication diagram between the user equipment, the mobile communication network, and the wireless access point, wherein the transmission of the emergency call capability information to the user equipment is shown in view of initiating an emergency call.

FIG. 3 schematically shows an attach procedure to the mobile communication network (especially to the mobile packet core network of the mobile communication network) using a wireless access point and an evolved packet data gateway.

### DETAILED DESCRIPTION

In an embodiment, the present invention provides an effective and simple solution to avoid situations as described in the background section, i.e. to assure that a user equipment can place an emergency call as quickly as possible even in case that the user equipment is connected to a mobile communication network (or core network of a mobile communication network).

In an embodiment, the present invention provides a method for improved handling of emergency calls of a user equipment being connected to a wireless access point while initiating an emergency call, wherein the user equipment is able to be connected to a mobile communication network via the wireless access point that is connected to an external packet data network, the mobile communication network comprising a core network and a radio access network, wherein the method comprises the following steps:
in a first step, the user equipment—while being attached to the mobile communication network—receives an emergency call capability information, the emergency call capability information being indicative of the mobile communication network providing the possibility of an emergency service towards the user equipment in case it is connected to the mobile communication network via the wireless access point,
in a second step and in case that an emergency call needs to be initiated by the user equipment while the user equipment is attached to the mobile communication network via the wireless access point, the user equipment initiates the emergency call via the wireless access point in case that the emergency call capability information indicates that the mobile communication network provides the possibility of an emergency service towards the user equipment while being connected to the mobile communication network via the wireless access point, and the user equipment initiates the emergency call using an access network of the mobile communication network different from the wireless access point in case that the emergency call capability information indicates that the mobile communication network is unable to provide the possibility of an emergency service towards the user equipment that is connected to the mobile communication network via the wireless access point.

It is thereby advantageously possible according to the present invention to provide the emergency call capability information to the user equipment such that the user equipment knows about the possibility (or not) to be able to (successfully) initiate an emergency call in a situation when the user equipment is connected to the mobile communication network (or the core network thereof). It is to be understood that typically, the emergency call capability information refers to the capability to initiate or place—for a given user equipment—an emergency call when connected to the mobile communication network via any wireless access point (that is able to be used with the considered mobile communication network), i.e. typically whether it is possible for a user equipment to place an emergency call when connected to a wireless access point (or whether this is not possible) is a property of the mobile communication network (or defined within the mobile communication network) and is typically applied to each (at least within a certain part of the mobile communication network) of the different (normally many) wireless access points that provide access to the mobile communication network. Furthermore, the transmission of the emergency call capability information towards the user equipment is typically not dependent on the user equipment having (at the moment of the transmission of this information) access to the mobile communication network via the wireless access point (i.e. the one used when placing the emergency call) or via another (of the plurality of wireless access point that are possible within the mobile communication network) wireless access point.

According to the present invention, the emergency call capability information includes one bit of information, i.e. the value of the emergency call capability information typically
either indicates that the mobile communication network provides the possibility of an emergency call service towards the user equipment while this user equipment is connected to the mobile communication network via the wireless access point,
or indicates that the mobile communication network is unable to provide the possibility of an emergency call service towards such a user equipment (i.e. being connected to the mobile communication network via the wireless access point).

In the second step according to the present invention, i.e. after the emergency call capability information has been transmitted to the user equipment, the user equipment will—dependent on the value of the emergency call capability information, i.e. whether or not it indicates that the mobile communication network provides the possibility of an emergency call service towards the user equipment while this user equipment is connected via the wireless access point to the core network—either initiate (or place) the emergency call via the wireless access point (in case the emergency call capability information indicates that this is possible) or refrain from doing so (in case the emergency call capability information indicates that this is not possible), i.e. in the latter case, in order to initiate an emergency call, the user equipment uses a different access to the mobile communication network (i.e. different to using the wireless access point), e.g. via a 2G access network (second generation or GSM (Global System for Mobile Communication) access network) and/or via a 3G access network (third generation or UMTS (Universal Mobile Telecommunication System) access network) and/or via a 4G access network (fourth generation or LTE (Long Term Evolution) access network).

Furthermore, in an embodiment, the present invention provides a method for improved handling of emergency calls of a user equipment being connected to a wireless access point while initiating an emergency call, wherein the user equipment is able to be connected to a mobile communication network via the wireless access point that is connected to an external packet data network, the mobile communication network comprising a core network and a radio access network, wherein the method comprises either (both) a first and a second step, or a third step:
in a first step, the user equipment—while being attached to the mobile communication network—receives an emergency call capability information, the emergency call capability information being indicative of the mobile communication network providing the possibility of an emergency service towards the user equipment in case it is connected to the mobile communication network via the wireless access point,
in a second step and in case that an emergency call needs to be initiated by the user equipment while the user equipment is attached to the mobile communication network via the wireless access point, the user equipment initiates the emergency call via the wireless access point in case that the emergency call capability information indicates that the mobile communication network provides the possibility of an emergency service towards the user equipment while being connected to the mobile communication network via the wireless access point, and the user equipment initiates the emergency call using an access network of the mobile communication network different from the wireless access point in case that the emergency call capability information indicates that the mobile communication network is unable to provide the possibility of an emergency service towards the user equipment that is connected to the mobile communication network via the wireless access point
in the third step and in case that an emergency call needs to be initiated by the user equipment while the user equipment is attached to the mobile communication network via the wireless access point, the user equipment initiates the emergency call using an access network of the mobile communication network different from the wireless access point in case that no emergency call capability information is received by the user equipment.

According to this embodiment of the present invention, it is also possible that no emergency call capability information is transmitted to the user equipment at all (or that the user equipment does not receive any emergency call capability information). According to the present invention in such a situation (i.e. in case the situation of the third step applies), the user equipment would not try to place an emergency call via the wireless access point it is connected to, but, rather, initiate the emergency call using an access network of the mobile communication network different from the wireless access point it is connected to. Such a behaviour of the user equipment results in refraining from initiating an emergency call via the wireless access point it is connected to in any situation the user equipment is not positively (i.e. via an emergency call capability information stating that emergency calls via WiFi access are possible) informed about the possibility of such an emergency call.

According to the present invention it is preferred that the user equipment is connected—while initiating the emergency call—via the wireless access point to the mobile communication network using a data transmission tunnel between the user equipment and an evolved packet data gateway that is part of the core network.

By using the data transmission tunnel, especially an IPSec-tunnel, it is advantageously possible according to the present invention that the security level of the connection, via the wireless access point, of the user equipment to the mobile communication network (or the (packet) core network of the mobile communication network) is comparable to a connection of the user equipment via a classical 2G/3G/4G access to the core network via an access network dedicated to be used with the mobile communication network.

According to a further embodiment of the present invention, it is also possible and preferred that the emergency call capability information is transmitted to the user equipment during performing an attach procedure in order to be attached to the mobile communication network, especially during performing the LTE attach procedure and especially during performing the attach procedure involving the evolved packet data gateway and the wireless access point or a different wireless access point.

According to the present invention, it is thereby advantageously possible that the emergency call capability information is transmitted to the user equipment right from the beginning of being connected (or attached) to the mobile communication network. In this respect, the attachment of the user equipment (during which the emergency call capability information is transmitted to the user equipment) can either be performed via a classical 2G/3G/4G access to the mobile communication network, i.e. via an access network different to the wireless access point. Alternatively, the emergency call capability information can be transmitted to the user equipment during an attachment procedure of the user equipment to the mobile communication network when the wireless access point serves as access network (or provides the functionality of the access network) to the mobile communication network.

According to the present invention it is furthermore preferred that the emergency call capability information is transmitted to the user equipment during initiating the data transmission tunnel between the wireless access point and the evolved packet data gateway.

According to the present invention, it is thereby advantageously possible that the emergency call capability information is transmitted to the user equipment even prior to the completion of the attachment procedure to the mobile communication network.

According to a further preferred embodiment of the present invention, the user equipment is connected to the mobile communication network via the wireless access point using an IP transportation tunnel between the evolved packet data gateway and a packet data network gateway that is part of the core network.

Thereby, it is advantageously possible according to the present invention that the connection, via the wireless access point, of the user equipment to the mobile communication network (or the (packet) core network of the mobile communication network) is comparable to a connection of the user equipment via a classical 2G/3G/4G access to the core network via an access network dedicated to be used with the mobile communication network, i.e. an IP transportation tunnel is established, realizing at least one GTP-tunnel (GPRS Tunnel Protocol-tunnel).

Furthermore, the present invention relates to a system for improved handling of emergency calls of a user equipment being connected to a wireless access point while initiating an emergency call, the system comprising the user equipment, the wireless access point, and a mobile communication network, wherein the user equipment is able to be connected to the mobile communication network via the wireless access point that is connected to an external packet data network, the mobile communication network comprising a core network and a radio access network, wherein the system is configured such that:
the user equipment—while being attached to the mobile communication network—receives an emergency call capability information, the emergency call capability information being indicative of the mobile communication network providing the possibility of an emergency service towards the user equipment in case it is connected to the mobile communication network via the wireless access point,
in case that an emergency call needs to be initiated by the user equipment while the user equipment is attached to the mobile communication network via the wireless access point, the user equipment initiates the emergency call via the wireless access point in case that the emergency call capability information indicates that the mobile communication network provides the possibility of an emergency service towards the user equipment while being connected to the mobile communication network via the wireless access point, and the user equipment initiates the emergency call using an access network of the mobile communication network different from the wireless access point in case that the emergency call capability information indicates that the mobile communication network is unable to provide the possibility of an emergency service towards the user equipment that is connected to the mobile communication network via the wireless access point, and optionally also additionally
in case that an emergency call needs to be initiated by the user equipment while the user equipment is attached to the mobile communication network via the wireless access point, the user equipment initiates the emergency call using an access network of the mobile communication network different from the wireless access point in case that no emergency call capability information is received by the user equipment.

Thereby, it is advantageously possible to provide a system such that the user equipment knows about the possibility (or not) to be able to (successfully) initiate an emergency call in a situation when the user equipment is connected to the mobile communication network (or the core network thereof).

Furthermore, the present invention relates to a mobile communication network for improved handling of emergency calls of a user equipment being connected to a wireless access point while initiating an emergency call, wherein the user equipment is able to be connected to a mobile communication network via the wireless access point that is connected to an external packet data network, the mobile communication network comprising a core network and a radio access network, wherein the mobile communication network is configured such that:
the user equipment—while being attached to the mobile communication network—receives an emergency call capability information, the emergency call capability information being indicative of the mobile communication network providing the possibility of an emergency service towards the user equipment in case it is connected to the mobile communication network via the wireless access point,
in case that an emergency call needs to be initiated by the user equipment while the user equipment is attached to the mobile communication network via the wireless access point, the user equipment initiates the emergency call via the wireless access point in case that the emergency call capability information indicates that the mobile communication network provides the possibility of an emergency service towards the user equipment while being connected to the mobile communication network via the wireless access point, and the user equipment initiates the emergency call using an access network of the mobile communication network different from the wireless access point in case that the emergency call capability information indicates that the mobile communication network is unable to provide the possibility of an emergency service towards the user equipment that is connected to the mobile communication network via the wireless access point, and optionally also additionally
in case that an emergency call needs to be initiated by the user equipment while the user equipment is attached to the mobile communication network via the wireless access point, the user equipment initiates the emergency call using an access network of the mobile communication network different from the wireless access point in case that no emergency call capability information is received by the user equipment.

Thereby, it is advantageously possible to provide the mobile communication network such that the user equipment knows about the possibility (or not) to be able to (successfully) initiate an emergency call in a situation when the user equipment is connected to the mobile communication network (or the core network thereof).

Furthermore, the present invention relates to a user equipment for improved handling of emergency calls of the user equipment being connected to a wireless access point while initiating an emergency call, the user equipment being provided to be used in an inventive system or with an inventive mobile communication network or for conducting a method according to the present invention.

Additionally, the present invention relates to a program comprising a computer readable program code which, when executed on a computer or on a network node of a home mobile communication network or on a network node of a visited mobile communication network, or in part on the network node of the home mobile communication network and in part on the network node of the visited mobile communication network, causes the computer or the network node of the home mobile communication network or the network node of the visited mobile communication network to perform the inventive method.

Still additionally, the present invention relates to a computer program product for a home mobile communication network and/or a visited mobile communication network, the computer program product comprising a computer program stored on a storage medium, the computer program comprising program code which, when executed on a computer or on a network node of a home mobile communication network or on a network node of a visited mobile communication network, or in part on the network node of the home mobile communication network and in part on the network node of the visited mobile communication network, causes the computer or the network node of the home mobile communication network or the network node of the visited mobile communication network to perform the inventive method.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

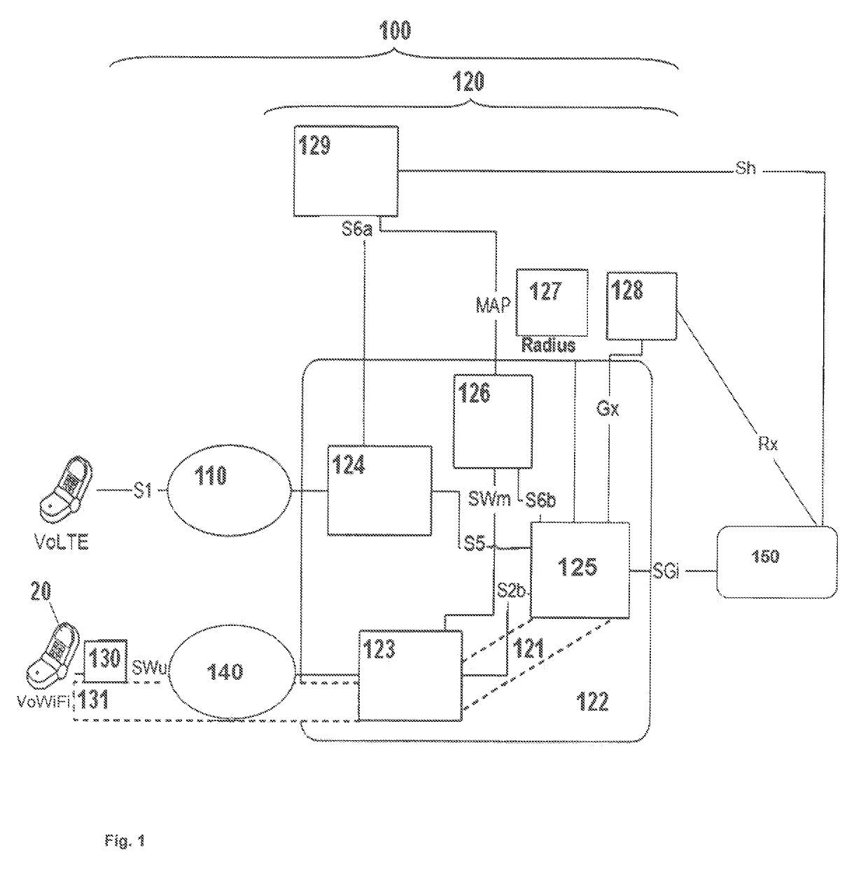

In FIG. 1, a mobile communication network 100 and a system according to the present invention is schematically shown. The mobile communication network 100 comprises an access network 110 (or a 3GPP radio access network 110) and a core network 120. Alternatively to the access network 110 (or 3GPP radio access network 110) for providing access to the mobile communication network 100, the mobile communication network 100 comprises (or is assigned or is related to) a least one wireless access point 130 but in reality typically a plurality of wireless access points 130. For the sake of simplicity, only one wireless access point 130 is represented in FIG. 1. Typically, the wireless access point 130 is connected to an external packet data network 140.

The core network 120 comprises a packet data core network 122 as well as a home location register/home subscriber server (HLR/HSS) 129, an authentication, authorization, and accounting node (AAA) 127, a policy and charging rules function (PCRF) 128. The packet data core network 122 comprises network nodes related to the 3GPP access network 110, especially one mobility management entity (MME) 124 or a plurality of mobility management entities (MME) 124 (typically for different geographical areas or parts of the mobile communication network 100). In the exemplary representation of FIG. 1, only one mobility management entity (MME) 124 is shown. Furthermore, the packet data core network 122 also comprises a PDN-gateway entity 125 or a packet data network gateway 125 (PGW—Packet Data Network (PDN) Gateway). A user equipment having access to the mobile communication network 100 via the access network 110 (or 3GPP access network 110) and via the mobility management entity 124 is typically connected via the packet data network gateway 125 to an IP Multimedia Subsystem (IMS) 150. The packet data core network 122 furthermore comprises an evolved packet data gateway 123, and an authentication, authorization, and accounting node regarding WiFi access (Wifi-AAA) 126. Alternatively to using the 3GPP access network 110, it is possible for a user equipment 20 to be connected to the mobile communication network 100 via the wireless access point 130 (and via the external packet data network 140). In this latter case, a data transmission tunnel 131—typically via an IPSec tunnel—is established between the user equipment 20 on the one hand and the evolved packet data gateway 123 on the other hand. Furthermore, an IP transportation tunnel 121 is established between the evolved packet data gateway 123 and the packet data network gateway 125. The interfaces as indicated in FIG. 1 are typically provided between the different elements of the mobile communication network 100, and especially the different elements of the data core network 122. For example, an SWu interface is provided between the wireless access point 130 and the evolved packet data gateway 123 (via the external packet data network 140); an S2b interface is provided between the evolved packet data gateway 123 and the packet data network gateway 125; a SWm interface is provided between the evolved packet data gateway 123 and the WiFi-AAA 126; a S6b interface is provided between the packet data network gateway 125 and the WiFi-AAA 126, and a SGi interface is provided between the packet data network gateway 125 and the IP Multimedia Subsystem (IMS) 150.

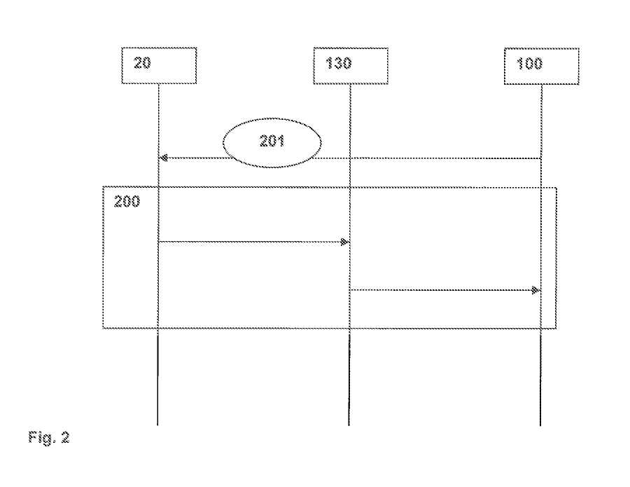

In FIG. 2, a communication diagram between the user equipment 20, the mobile communication network 100, and the wireless access point 130 is schematically shown, wherein the transmission of the emergency call capability information 201 to the user equipment 20 is shown in view of initiating an emergency call. The emergency call capability information 201 includes at least one bit of information, i.e. the value of the emergency call capability information 201 typically
either indicates that the mobile communication network 100 provides the possibility of an emergency call service towards the user equipment 20 while this user equipment 20 is connected to the mobile communication network 100 via the wireless access point 130,
or indicates that the mobile communication network 100 is unable to provide the possibility of an emergency call service towards such a user equipment 20 (i.e. being connected to the mobile communication network 100 via the wireless access point 130). The emergency call capability information 201 is transmitted to the user equipment 20 prior to the initiation of an emergency call 200 by that user equipment 20 (while connected to the mobile communication network 100 via the wireless access point 130). However, according to the present invention, the emergency call capability information 201 is either transmitted to the user equipment 20 during the attachment procedure of the user equipment 20 to the mobile communication network 100 or at a later moment (while the user equipment 20 is connected to the mobile communication network 100).

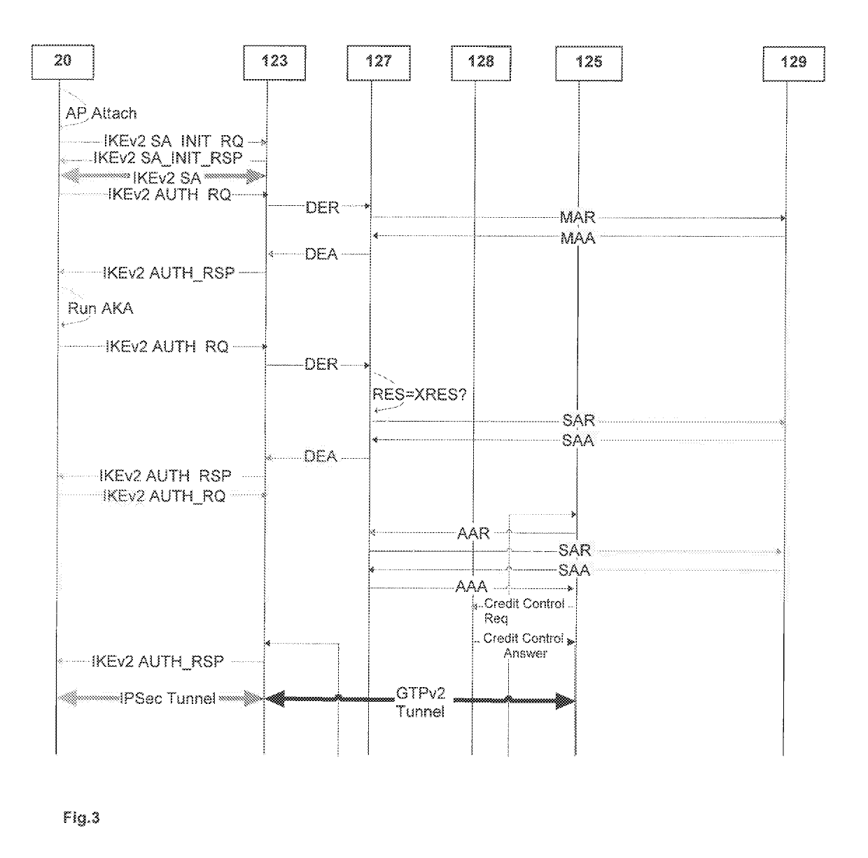

In FIG. 3, an attach procedure of the user equipment 20 to the mobile communication network 100 (especially to the mobile packet core network 122 of the mobile communication network 100) using a wireless access point 130 and an evolved packet data gateway 123 is schematically shown. FIG. 3 corresponds to a communication diagram between the user equipment 20, the evolved packet data gateway 123, the authentication, authorization, and accounting node (AAA) 127, the policy and charging rules function (PCRF) 128, the packet data network gateway 125, and the home location register/home subscriber server (HLR/HSS) 129.

In a first processing step, the user equipment 20 attaches to the wireless access point 130, indicated in FIG. 3 by “AP attach”. In a second processing step, the user equipment 20 transmits a IKEv2 SA_INIT_RQ message to the evolved packet data gateway 123, requesting the initiation of an IPSec tunnel. In a third processing step, the evolved packet data gateway 123 transmits a IKEv2 SA_INIT RSP message to the user equipment 20, which results in the establishment of a security association between the user equipment 20 and the evolved packet data gateway 123, indicated by the double arrow “IKEv2 SA” in FIG. 3. In a fourth processing step, the user equipment 20 transmits a IKEv2 Auth_RQ (authentication request) to the evolved packet data gateway 123. In a fifth processing step, the evolved packet data gateway 123 transmits a DER (Diameter EAP (Extensible Authentication Protocol) Request) to the authentication, authorization, and accounting node (AAA) 127. In a sixth processing step, the authentication, authorization, and accounting node (AAA) 127 transmits a MAR (Multimedia Authentication Request) to the home location register/home subscriber server (HLR/HSS) 129. In a seventh processing step, the home location register/home subscriber server (HLR/HSS) 129 transmits a MAA (Multimedia Authentication Answer) to the authentication, authorization, and accounting node (AAA) 127. In an eighth processing step, the authentication, authorization, and accounting node (AAA) 127 sends a DEA (Diameter EAP Answer) to the evolved packet data gateway 123. In a ninth processing step, the evolved packet data gateway 123 transmits an IKEv2 AUTH_RSP (authentication response) to the user equipment 20. In a tenth processing step, the user equipment 20 runs an Authentication and Key Agreement protocol (AKA). In an eleventh processing step, the user equipment 20 transmits a IKEv2 AUTH_RQ (authentication request) to the evolved packet data gateway 123. In a twelfth processing step, the evolved packet data gateway 123 transmits a DER to the authentication, authorization, and accounting node (AAA) 127. In a thirteenth processing step, the authentication, authorization, and accounting node (AAA) 127 runs a verification step, indicated by “RES=XRES?” in FIG. 1. In a fourteenth processing step, the authentication, authorization, and accounting node (AAA) 127 transmits a SAR message (Server Assignment Request) to the home location register/home subscriber server (HLR/HSS) 129. In a fifteenth processing step, the home location register/home subscriber server (HLR/HSS) 129 transmits a SAA message (Server Assignment Answer) to the authentication, authorization, and accounting node (AAA) 127. In a sixteenth processing step, the authentication, authorization, and accounting node (AAA) 127 transmits a DEA to the evolved packet data gateway 123. In a seventeenth processing step, the evolved packet data gateway 123 transmits a IKEv2 AUTH_RSP (authentication response) to the user equipment 20. A further IKEv2 AUTH_RQ (authentication request) from the user equipment 20 to the evolved packet data gateway 123 triggers further processing steps indicated in FIG. 3 that result in a further IKEv2 AUTH_RSP message from the evolved packet data gateway 123 to the user equipment 20 until both the data transmission tunnel 131 (IPSec Tunnel) between the user equipment 20 and the evolved packet data gateway 123, and the IP transportation tunnel 121 between the evolved packet data gateway 123 and the packet data network gateway 125 is established.

According to the present invention, the user equipment 20 uses an existing WiFi connection (to a wireless access point 130) to create an IPSec tunnel to the evolved packet data gateway 123 (i.e. a network element in the mobile operator domain). Via the evolved packet data gateway 123 (or ePDG), the user equipment 20 can connect to the Mobile Enhanced Packet Core (EPC) 122 and register to IMS 150 for multimedia telephony services. According to the present invention, WiFi Emergency Call (i.e. the possibility for a user equipment 20 to initiate an emergency call while connected via a wireless access point 130) requires support from both the user equipment 20 and the mobile communication network 100. According to the present invention, it can be assured that before an attempt (of an emergency call) is made, the user equipment 20 is aware that such functionality is supported by the mobile communication network 100. Trying WiFi Emergency Call in a mobile communication network 100 not supporting this functionality will result in a failure with highly undesirable consequences. According to the present invention, it is advantageously possible to provide a dynamic procedure for the user equipment 20 to discover whether or not the mobile communication network 100 to which it is connected via WiFi (i.e. via the wireless access point 130) supports WiFi Emergency Calls or not. Furthermore, it is advantageously possible to provide a behaviour of the user equipment 20 whereby the user equipment 20 will try to re-select a different network or a different radio access technology rather than attempting a WiFi Emergency Call, if the mobile communication network 100 has indicated that WiFi Emergency Calls are not supported. According to the present invention, upon the connection to a mobile communication network 100 using WiFi access (i.e. access via a wireless access point 130) as one alternative of perhaps different access possibilities, the user equipment 20 receives an indication (via the emergency call capability information 201) from the mobile communication network 100 as to whether WiFi Emergency Call capability is supported or not. This indication may be sent at initial attach or at any time prior the user equipment 20 attempts an emergency call over WiFi.

If the mobile communication network 100 does not indicate the support of WiFi emergency calls or if the mobile communication network 100 indicates that it does not support WiFi emergency calls, then the user equipment 20 will not attempt to initiate a WiFi Emergency Call and will instead attempt to either select a different radio access technology or a different network.

In an embodiment, the user equipment 20 discovers the network WiFi Emergency Call capability (i.e. receives the emergency call capability information 201) during the LTE attach procedure.

According to the present invention, it is possible that the IKEv2 protocol is used to transmit the emergency call capability information 201 (i.e. the WiFi Emergency Call capability indication), e.g. the Notify payload in the IKE SA_INIT response sent from the evolved packet data gateway 123 (ePDG) to the user equipment 20 can be used for indicating the WiFi Emergency Call capability (emergency call capability information 201) in the Notify payload section of the message.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for handling emergency calls, comprising:
receiving, by a user equipment attached to a mobile communication network, emergency call capability information indicative of whether the mobile communication network supports an emergency service for the user equipment in a case where the user equipment is connected to the mobile communication network via a wireless access point connected to an external packet data network; and
initiating, by the user equipment, an emergency call via the wireless access point or via an access network of the mobile communication network different from the wireless access point based on whether or not the emergency call capability information indicates that the mobile communication network supports the emergency service for the user equipment in the case where the user equipment is connected to the mobile communication network via the wireless access point.

2. The method according to claim 1, wherein, while initiating the emergency call, the user equipment is connected via the wireless access point to the mobile communication network using a data transmission tunnel between the user equipment and an evolved packet data gateway that is part of a core network of the mobile communication network.

3. The method according to claim 1, wherein the emergency call capability information is transmitted to the user equipment during an attach procedure for attaching the user equipment to the mobile communication network.

4. The method according to claim 1, wherein the emergency call capability information is transmitted to the user equipment during initiation of a data transmission tunnel between the wireless access point and an evolved packet data gateway.

5. The method according to claim 1, wherein the emergency call capability information is transmitted to the user equipment after an attach procedure for attaching the user equipment to the mobile communication network and/or after initiation of a data transmission tunnel between the wireless access point and an evolved packet data gateway.

6. The method according to claim 1, wherein the wireless access point is a WiFi access point.

7. The method according to claim 2, wherein the data transmission tunnel is an IP Sec Tunnel.

8. The method according to claim 1, wherein the user equipment is connected to the mobile communication network via the wireless access point using an IP transportation tunnel between an evolved packet data gateway and a packet data network gateway that are part of a core network of the mobile communications network.

9. A system for emergency calls, comprising:
a user equipment;
a wireless access point; and
a mobile communication network;
wherein the user equipment is connected to the mobile communication network via the wireless access point, which is connected to an external packet data network;
wherein the mobile communication network comprises a core network and a radio access network;
wherein the user equipment is configured to, while being attached to the mobile communication network, receive an emergency call capability information indicative of whether the mobile communication network supports an emergency service for the user equipment in a case where the user equipment is connected to the mobile communication network via the wireless access point;
wherein the user equipment is configured to initiate an emergency call via the wireless access point or via an access network of the mobile communication network different from the wireless access point based on whether or not the emergency call capability information indicates that the mobile communication network supports the emergency service for the user equipment in the case where the user equipment is connected to the mobile communication network via the wireless access point.

10. A non-transitory, computer-readable medium having processor-executable instructions stored thereon for handling emergency calls, the processor-executable instructions, when executed, facilitating performance of the following:
receiving, by a user equipment attached to a mobile communication network, emergency call capability information indicative of whether the mobile communication network supports an emergency service for the user equipment in a case where the user equipment is connected to the mobile communication network via a wireless access point connected to an external packet data network; and
initiating, by the user equipment, an emergency call via the wireless access point or via an access network of the mobile communication network different from the wireless access point based on whether or not the emergency call capability information indicates that the mobile communication network supports the emergency service for the user equipment in the case where the user equipment is connected to the mobile communication network via the wireless access point.
